(19) United States
(12) Patent Application Publication
(10) Pub. No.: US 2006/0133355 A1
(43) Pub. Date: Jun. 22, 2006

(54) Methods, systems and computer program products for error correction by retransmitting errored packets over a data link

(76) Inventor: Thomas Anschutz, Conyers, GA (US)

Correspondence Address: MYERS BIGEL SIBLEY & SAJOVEC, P.A., P.O. BOX 37428, RALEIGH, NC, 27627, US

(21) Appl. No.: 11/269,286

(22) Filed: Nov. 8, 2005

Related U.S. Application Data
(63) Continuation-in-part of application No. 11/021,183, filed on Dec. 22, 2004.

(51) Int. Cl. H04L 12/66

(52) U.S. Cl. 370/352

(57) ABSTRACT

Methods, systems and computer program products are provided for providing error correction in a communication network. A frame including a retransmission class of service indication in associated network layer forwarding information is received. It is determined if the received frame has been corrupted. Retransmission of the received frame is requested if it is determined that it the received framed has been corrupted. An uncorrupted version of the received frame is retransmitted responsive to the retransmission request, over a data link.

### RELATED APPLICATION

The present application is a continuation in part of and claims priority from U.S. patent application Ser. No. 11/021,183 to Anschutz et al., filed Dec. 22, 2004 entitled Methods, Systems, and Computer Program Products for Operating a Communication Network by Performing Forward Error Correction and/or Interleaving Based on Network Layer Forwarding Information, the disclosure of which is hereby incorporated herein by reference as if set forth in its entirety.

### FIELD OF THE INVENTION

The present invention relates to communication networks and, more particularly, to methods, systems and computer program products for error correction in communication networks.

### BACKGROUND OF THE INVENTION

Digital subscriber line (DSL) and other communication network transport technologies allow for use of forward error correction (FEC) and interleaving techniques to improve bit error rates (BER) in exchange for increased latency and reduced bandwidth. For example, FEC techniques typically involve the practice of adding redundancy to a digital transmission to enable transmission errors to be detected and corrected at the receiver. This added redundancy may add 10 to 20 percent more overhead on the lines, which may cause a problem for certain types of data. For example, for video data transmitted over DSL lines, the video bandwidth may quickly run out. Commonly used types of forward error correction codes include trellis codes, convolutional codes, and Reed Solomon codes. Thus, FEC codes may add overhead to a digital transmission thereby consuming some bandwidth that would otherwise be available for transmission of a data payload.

Interleaving refers to the practice of transmitting the data associated with a frame across several frames. Thus, each transmitted frame includes portions of data from several logical frames. By mixing the data up in this manner, impulse noise that may otherwise affect several bits in a row across a single frame will instead corrupt a few bits spread across many frames. It is generally easier to correct the errors when the corrupted bits are not grouped together. Unfortunately, interleaving may increase the latency in a communication network because a receiver typically waits until many frames are received before it can begin processing the frames to correct any errors and deinterleave the data to reassemble the logical frames.

Traditionally, FEC and interleaving parameters are set to a single set of values. For example, referring now to FIG. 1, functional elements of a conventional DSL communications device 100 are shown in which several network transport protocol modules, including a plain old telephone service (POTS) protocol module 105, integrated services digital network (ISDN) protocol module 110, E1/T1 protocol module 115, optical carrier (OC), ie., synchronous optical network (SONET) protocol module 120, asynchronous transfer mode (ATM) protocol module 125, and Internet Protocol, e.g., point-to-point protocol module 130, are coupled to a multiplexer module 135. The multiplexer 135 multiplexes frames from the various network layer protocols into a transport layer protocol responsive to a synch signal. The frames may then be processed at the transport layer using a scrambler 140, a FEC module 145, and/or an interleaver module 150 where they may then be provided to a core modem 155 for transmission into a core of the communication network. The FEC module 145 and the interleaver module 150 use the same FEC parameters and interleave parameters, respectively, for all network layer protocols. This set of parameters may not be optimal, however, for all network layer protocols. For example, some applications, such as voice, may place higher emphasis on bandwidth and/or low latency and may be tolerant of more errors than would a data application.

This problem may be addressed through the use of the multiple bearer capability of DSL. Referring now to FIG. 2, a conventional network 200 includes the same network layer protocols as illustrated in FIG. 1. Rather than multiplexing all network layer frames onto a single transport layer bearer, two multiplexers 205 and 210 may be used to multiplex some network layer frames onto one DSL bearer and other network layer frames onto another DSL bearer. As shown in FIG. 2, the POTS 105 and ISDN 110 network layer frames are multiplexed onto a first DSL bearer where they are processed by a scrambler module 215 at the transport layer. Because the POTS 105 and ISDN 110 frames are carrying voice, there is no need to perform FEC and/or interleaving in the transport layer. The remaining network layer protocols, however, are multiplexed onto a second DSL bearer where they are processed by a scrambler module 220, a FEC module 225, and an interleaver 230. Thus, those network layer frames that carry data may be multiplexed onto the second DSL bearer where FEC and interleaving may be applied at the transport layer. The transport layer frames may then be multiplexed using the multiplexer 235 to the core modem 240 responsive to a synchronization signal. While the architecture of FIG. 2 may allow for different FEC and/or interleave treatment for different network layer frames, the architecture also involves the use of multiple logical links at the transport layer corresponding to the multiple bearers, reduced maximum bit rates for each logical link (i.e., bearer), increased latency for each logical link on which interleaving is applied, and statically divided (or fragmented) bandwidth among the logical links/bearers.

### SUMMARY OF THE INVENTION

Some embodiments of the present invention provide methods, systems and computer program products for providing error correction in a communication network. A frame including a retransmission class of service indication in associated network layer forwarding information is received. It is determined if the received frame has been corrupted. Retransmission of the received frame is requested if it is determined that the received framed has been corrupted. An uncorrupted version of the received frame is retransmitted responsive to the retransmission request, over a data link.

In further embodiments of the present invention, at least one frame including the retransmission class of service indication may be stored in a dedicated buffer or queue. The at least one frame stored in the dedicated buffer or queue may be selected to be transmitted. The selected at least one frame is transmitted over the data link. The received frame may be retransmitted over the data link responsive to the retransmission request.

In further embodiments of the present invention, the selecting, transmitting and retransmitting may be performed by a transmitting modem and the receiving a frame, determining, requesting and receiving an uncorrupted frame may be performed by a receiving modem.

In some embodiments of the present invention, the network layer forwarding information may include a packet marking and/or a virtual circuit label. The network layer forwarding information may be assigned by an ADSL transceiver unit or a VDSL transceiver unit. The retransmission class of service may be associated with video data for use in internet protocol television (IPTV) applications.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a conventional single link/bearer DSL communication device architecture.

FIG. 2 is a block diagram that illustrates a conventional multiple link/bearer communication network architecture.

FIG. 3 is a block diagram that illustrates a network architecture in which forward error correction (FEC), interleaving and/or retransmission are performed based on network layer forwarding information according to some embodiments of the present invention.

FIG. 4 is a simplified block diagram illustrating retransmission according to some embodiments of the present invention.

FIG. 5 is a flowchart illustrating methods, systems and computer program products for error correction in a communication network according to some embodiments of the present invention.

FIG. 6 is a more detailed flowchart illustrating methods, systems and computer program products for error correction in a communication network according to further embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a frame or frames. It will be understood that the term “frame” means a unit of information and/or a block of data that may be transmitted electronically as a whole or via segments from one device to another. Accordingly, as used herein, the term “frame” may encompass such terms of art as “packet” and/or “message,” which may also be used to refer to a unit of transmission.

As used herein, the term “protocol” refers to a defined set of rules that govern the exchange of data or information between two or more entities. In addition, a “protocol layer” refers to the hierarchical protocol structure represented by the open systems interconnection (OSI) model developed by the International Organization for Standardization in which layer one corresponds to the physical layer, layer two corresponds to the data link layer, layer three corresponds to the network layer, layer four corresponds to the transport layer, layer five corresponds to the session layer, layer six corresponds to the presentation layer, and layer seven corresponds to the application layer.

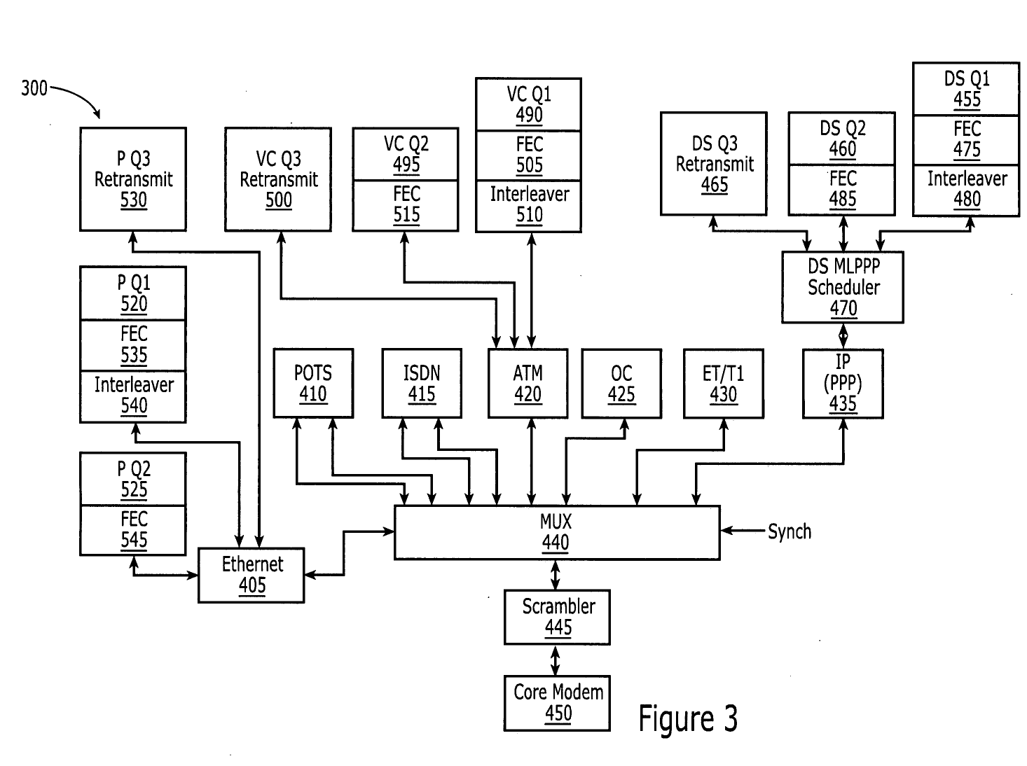

Some embodiments of the present invention will now be discussed with respect to FIGS. 3 through 6. As illustrated therein, a communication network architecture in which forward error correction (FEC), interleaving and/or retransmission are performed based network layer forwarding information, in accordance with some embodiments of the present invention, will now be described. As will be discussed further below, certain types of data may not tolerate the overhead associated with FEC and interleaving according to some embodiments of the present invention. For example, video transmitted over DSL lines cannot tolerate a lot of errors, so error correction may be necessary. However, the overhead occupied by the error correction schemes may cause the video bandwidth to run out. Accordingly, in embodiments of the present invention having a video data type, for example, internet protocol television (IPTV) or video over ADSL (VDSL), a corrupted frame may be retransmitted. In other words, video data may be provided with its own class of service which causes a frame that has been determined to be corrupted to be retransmitted over the data link as discussed further below. It will be understood that the retransmission class of service is not limited to video data types as discussed herein.

Referring first to FIG. 3, an exemplary communication network architecture 300 in which forward error correction (FEC), interleaving and/or retransmission are performed based on network layer forwarding information, in accordance with some embodiments of the present invention, will now be described. The communication network comprises several network layer protocol modules, including an Ethernet protocol module 405, plain old telephone service (POTS) protocol module 410, integrated services digital network (ISDN) protocol module 415, asynchronous transfer mode (ATM) protocol module 420, optical carrier (OC), i.e., synchronous optical network (SONET) protocol module 425, E1/T1 protocol module 430, and Internet Protocol, for example, point-to-point protocol module 435, that are coupled to a multiplexer 440.

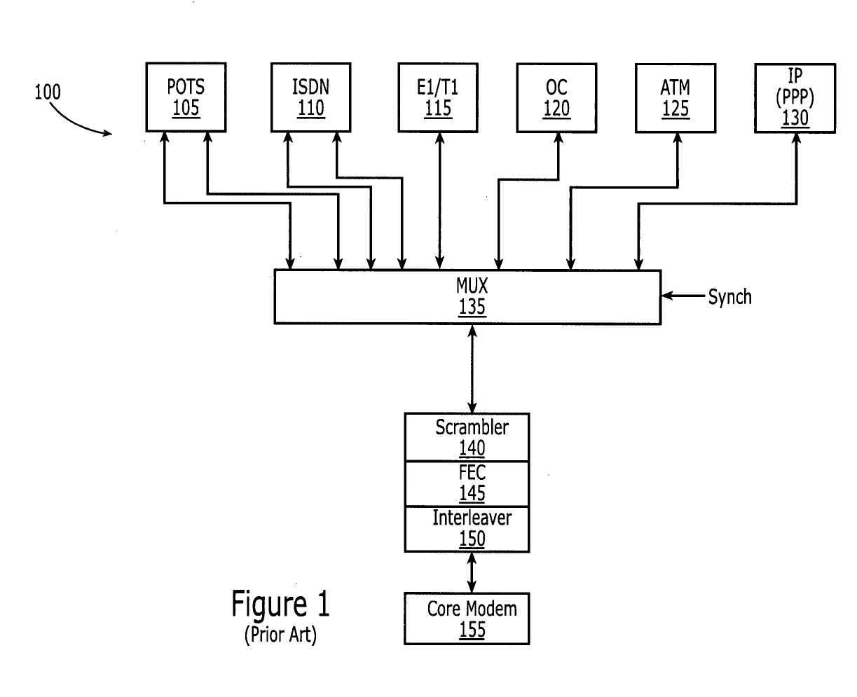

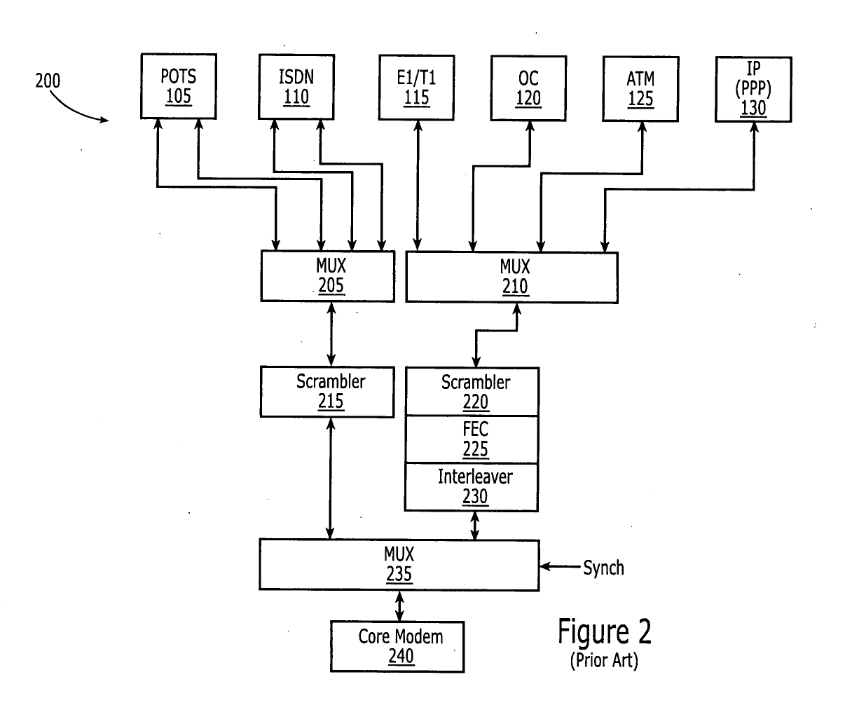

The multiplexer 440 multiplexes frames from the various network layer protocols and/or forwarding classes into a transport layer protocol responsive to a synch signal. The transport layer protocol may be associated with a single DSL bearer in accordance with some embodiments of the present invention. The frames may then be processed at the transport layer using a scrambler 445 where they may then be provided to a core modem 450 for transmission in a DSL or other communication network 400. Thus, in sharp contrast to the architecture of FIG. 1, FEC and/or interleaving are not performed at the transport layer thereby applying the same FEC and/or interleaving treatment to frames associated with all of the different network layer protocols and/or forwarding classes. Moreover, in sharp contrast to the architecture of FIG. 2, multiple transport layer links or bearers are not used thereby statically dividing the bandwidth between the multiple transport layer links/bearers with each link receiving FEC treatment having a reduced bandwidth and each link receiving interleaving treatment having increased latency. According to some embodiments of the present invention, FEC, retransmission and/or interleaving are performed based on network layer forwarding information as will be described below.

Furthermore, according to some embodiments of the present invention, neither interleaving nor FEC may be implemented. In these embodiments of the present invention, the network layer forwarding information may indicate a retransmission class of service for the frame. When a frame is received, for example, at the a receiving modem (core modem 450), having this indication, it may be determined if the received frame has been corrupted. If it is determined that the received frame has been corrupted, the receiving modem may be configured to request that the transmitting modem resend the corrupted frame over the data link. Thus, according to some embodiments of the present invention, error correction may be provided without any significant overhead, which may free up bandwidth for certain types of data, for example, video, as discussed further herein.

Referring to FIG. 3, the IP/PPP protocol module 435 has a plurality of differentiated services (diffserv) buffers and/or queues 455, 460, and 465 that are coupled to the IP/PPP protocol module 435 via a differential services (multi-link PPP) scheduler module 470. The differential services (multi-link PPP) scheduler module 470 is a statistical multiplexer that schedules frames from the differentiated services (diffserv) buffers and/or queues 455, 460, and 465 to the IP/PPP protocol module 435. As shown in FIG. 3, frames stored in the diffserve buffer and/or queue 455 are processed via a FEC module 475 and an interleaver module 480. By contrast, frames stored in the diffserve buffer and/or queue 460 are processed via a FEC module 485. The diffserve buffer and/or queue 465 may be the used for the frames having a retransmit class of service according to some embodiments of the present invention. Thus, for example, the frames stored in the diffserve buffer or queue 465 may include an indication that if corrupted the frame should be retransmitted over the data link. It will be understood that although not illustrated in FIG. 3, one or more other diffserve buffer and/or queues may be provided for frames that are not processed via a FEC module, an interleaver module or retransmitted. Thus, IP/PPP frames may receive FEC and/or interleaver treatment or be retransmitted over the data link when corrupted or not receive FEC and/or interleaver treatment or be retransmitted based on which buffer and/or queue a respective frame is assigned to. The IP/PPP frames may be assigned to a particular diffserve buffer and/or queue based on a differentiated services code point (DSCP) value assigned to an IP/PPP packet. For example, a DSCP value may indicate that a frame should be assigned to the retransmit queue 465.

Similarly, the ATM protocol module 420 has a plurality of virtual circuit buffers and/or queues 490, 495, and 500 that are analogous to the diffserve buffers and/or queues 455, 460, and 465, respectively. That is, frames stored in the virtual circuit buffer and/or queue 490 are processed via a FEC module 505 and an interleaver module 510, frames stored in the virtual circuit buffer and/or queue 495 are processed via a FEC module 515, and frames stored in the virtual circuit buffer and/or queue 500 may be retransmitted if corrupted (ie., belong to the retransmit class of service). It will be understood that although not illustrated in FIG. 3, one or more virtual circuit buffers and/or queues may be provided that include frames that do not receive FEC or interleaver treatment or are not retransmitted upon corruption. The ATM protocol module 420 may include a statistical multiplexer function for scheduling packets from the three virtual circuit buffers and/or queues 490, 495, and 500. Because of the provisioned nature of ATM PVCs, it may be possible to associate various ATM PVCs with the FEC, interleaver and retransmission functions regardless of the ATM class of service.

The Ethernet protocol module 405 has a plurality of 802.1P buffers and/or queues 520, 525, and 530 that are analogous to the diffserve buffers and/or queues 455, 460, and 465, respectively. That is, frames stored in the 802.1P buffer and/or queue 520 are processed via a FEC module 535 and an interleaver module 540, frames stored in the 802.1P buffer and/or queue 525 are processed via a FEC module 545, and frames stored in the 802.1P buffer and/or queue 530 may be retransmitted over the data link if corrupted. It will be understood that although not illustrated in FIG. 3, one ore more 802.1P buffers and/or queues may include frames that do not receive FEC, interleaver or retransmission treatment. The Ethernet protocol module 405 may include a statistical multiplexer function for scheduling packets from the three 802.1P buffers and/or queues 520, 525, and 530.

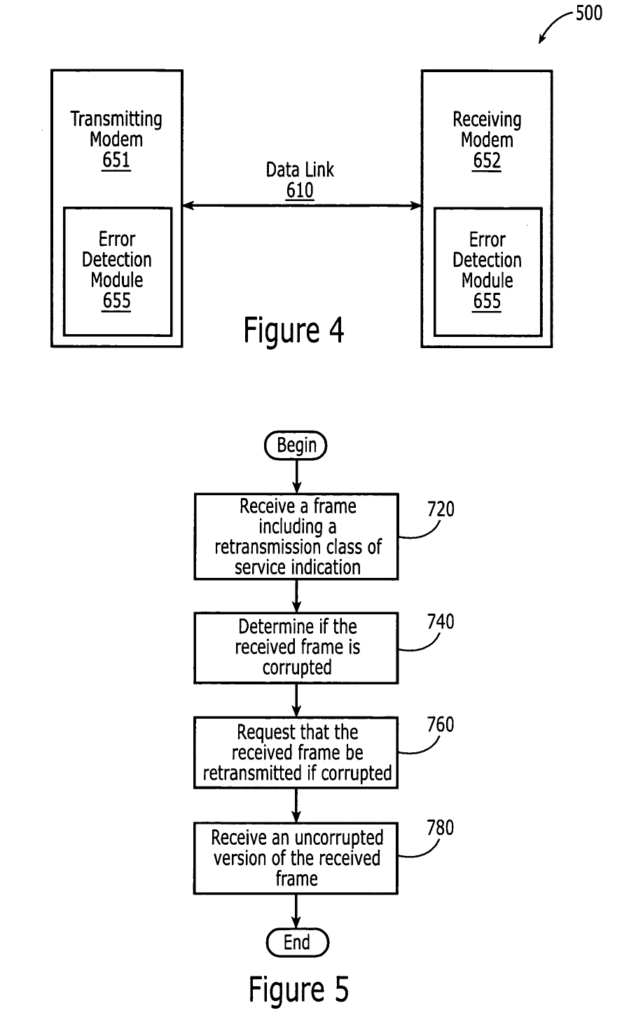

Referring now to FIG. 4, retransmission of corrupted frames according to some embodiments of the present invention will be discussed with respect to the network 400 of FIG. 4. It will be understood that the block diagram is a simplified diagram provided for exemplary purposes only, therefore, only the modems and data link are illustrated. However, other elements that would make the system operable are also present, but not illustrated.

As discussed above, frames that are associated with the retransmission class of service may be stored in a dedicated buffer or queue. These frames may also be marked to indicate that they should be retransmitted if corrupted. For example, the network layer forwarding information, such as packet markings and/or virtual circuit labels, may indicate that a frame has been designated to be retransmitted if corrupted, i.e., the frame has been designated to have a retransmission class of service. In some embodiments of the present invention an ADSL Transceiver Unit (ATU) or VDSL transceiver unit (VTU) may be configured to mark the frame.

As illustrated in FIG. 4, a transmitting modem 651 may transmit one or more frames designated as having a retransmission class of service to a receiving modem 652 over the data link 610. Once a frame is received at the receiving modem 652, the receiving modem 652 may be configured to determine if the received frame has been corrupted. As further illustrated in FIG. 4, each modem includes an error detection module 655 that is configured to determine if the frame has been corrupted. It will be understood that the error detection module 655 is provided in the modems for exemplary purposes only and that embodiments of the present invention are not limited to this configuration. The error correction module 655 may be included in other elements of the network without departing from the scope of the present invention.

If the error detection module 655 detects that the received frame has been corrupted, the receiving modem 652 may be further configured to request that the transmitting modem 651 retransmit the corrupted frame over the data link 610. Thus, according to some embodiments of the present invention, error correction may be provided without the added overhead of FEC and/or interleaving. These embodiments of the present invention may be well suited to systems that do not routinely have a lot of errors, for example, one error every hour or half hour. Furthermore, these embodiments may be especially useful in the transmission of data where the bandwidth may be limited, for example, video. Accordingly, retransmission embodiments of the present invention may used in combination with IPTV applications that typically have low BER requirements and high throughput requirements.

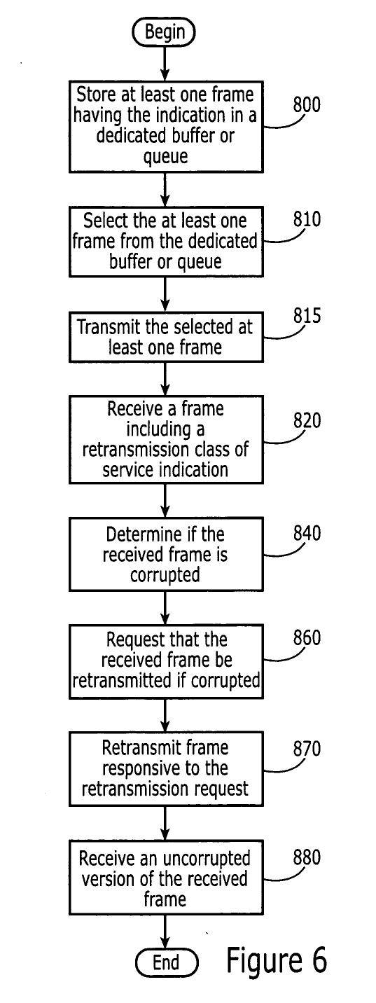

Exemplary operations for providing error correction in a communications network according to some embodiments of the present invention will now be described with reference to FIGS. 5 and 6. Referring first to FIG. 5, operations begin at block 720 by receiving a frame including a retransmission class of service indication in associated network layer forwarding information. As discussed above, in some embodiments of the present invention, the retransmission class of service may be associated with video data for use in internet protocol television (IPTV) applications. The received frame may be received at, for example, a receiving modem. In some embodiments of the present invention, network layer forwarding information may include a packet marking and/or a virtual circuit label and may be assigned by a ADSL transceiver unit or a VDSL transceiver unit. It is determined if the received frame has been corrupted (block 740). If it is determined that it the received framed has been corrupted (block 740), it is requested that the frame be retransmitted (block 760). An uncorrupted version of the received frame is received responsive to the retransmission request over a data link (block 780).

Referring now to FIG. 6, operations begin at block 800 by storing at least one frame including the retransmission class of service indication in a dedicated buffer or queue. The at least one frame stored in the dedicated buffer or queue may be selected to be transmitted by, for example, a transmitting modem (block 810). The selected at least one frame may be transmitted over the data link (block 815). The frame including a retransmission class of service indication in associated network layer forwarding information may be received at, for example, a receiving modem (block 820). It is determined if the received frame has been corrupted (block 840). If it is determined that it the received framed has been corrupted (block 840), it is requested that the frame be retransmitted (block 860). The uncorrupted version of the frame may be retransmitted (block 870) and the uncorrupted version of the received frame may be received responsive to the retransmission request over a data link (block 880).

The flowcharts of FIGS. 5 and 6 illustrate the architecture, functionality, and operations of some embodiments of methods, systems, and computer program products for error correction in a network environment, in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIGS. 5 and 6. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of providing error correction in a communication network, comprising:
receiving a frame including a retransmission class of service indication in associated network layer forwarding information;
determining if the received frame has been corrupted;
requesting retransmission of the received frame if it is determined that it the received framed has been corrupted; and
receiving an uncorrupted version of the received frame, responsive to the retransmission request, over a data link.

2. The method of claim 1, wherein receiving a frame is preceded by:
storing at least one frame including the retransmission class of service indication in a dedicated buffer or queue and wherein the method further comprising:
selecting the at least one frame stored in the dedicated buffer or queue to be transmitted; and
transmitting the selected at least one frame over the data link.

3. The method of claim 2, wherein requesting retransmission is followed by retransmitting the received frame over the data link responsive to the retransmission request.

4. The method of claim 3, wherein selecting, transmitting and retransmitting are performed by a transmitting modem and receiving a frame, determining, requesting and receiving an uncorrupted frame are performed by a receiving modem.

5. The method of claim 1, wherein the network layer forwarding information comprises a packet marking and/or a virtual circuit label.

6. The method of claim 5, wherein the network layer forwarding information is assigned by a ADSL transceiver unit or a VDSL transceiver unit.

7. The method of claim 1, wherein the retransmission class of service is associated with video data for use in internet protocol television (IPTV) applications.

8. A system for providing error correction in a communication network, comprising:
a receiving modem configured to:
receive a frame including a retransmission class of service indication in associated network layer forwarding information;
determine if the received frame has been corrupted;
request retransmission of the received frame if it is determined that it the received framed has been corrupted; and
receive an uncorrupted version of the received frame, responsive to the retransmission request, over a data link.

9. The system of claim 8, further comprising:
a dedicated queue and/or buffer configured to store at least one frame including the retransmission class of service indication.

10. The system of claim 9, further comprising:
a transmitting modem configured to:
select the at least one frame stored in the dedicated buffer or queue to be transmitted; and
transmit the selected at least one frame over the data link.

11. The system of claim 10, wherein the transmitting modem is further configured to retransmit the received frame over the data link responsive to the retransmission request.

12. The system of claim 8, wherein the network layer forwarding information comprises a packet marking and/or a virtual circuit label.

13. The system of claim 12, wherein the network layer forwarding information is assigned by a ADSL transceiver unit or a VDSL transceiver unit.

14. The system of claim 8, wherein the retransmission class of service is associated with video data for use in internet protocol television (IPTV) applications.

15. A computer program product for providing error correction in a communication network, the computer program product comprising:
a computer readable storage medium having computer readable program code embodied therein, the computer readable program code comprising:
computer readable program code configured to receive a frame including a retransmission class of service indication in associated network layer forwarding information;
computer readable program code configured to determine if the received frame has been corrupted;
computer readable program code configured to request retransmission of the received frame if it is determined that it the received framed has been corrupted; and
computer readable program code configured to receive an uncorrupted version of the received frame, responsive to the retransmission request, over a data link.

16. The computer program product of claim 15, further comprising:
computer readable program code configured to store at least one frame including the retransmission class of service indication in a dedicated buffer or queue;
computer readable program code configured to select the at least one frame stored in the dedicated buffer or queue to be transmitted; and
computer readable program code configured to transmit the selected at least one frame over the data link.

17. The computer program product of claim 16, further comprising computer readable program code configured to retransmit the received frame over the data link responsive to the retransmission request.

18. The computer program product of claim 15, wherein the network layer forwarding information comprises a packet marking and/or a virtual circuit label.

19. The computer program product of claim 18, wherein the network layer forwarding information is assigned by a ADSL transceiver unit or a VDSL transceiver unit.

20. The computer program product of claim 15, wherein the retransmission class of service is associated with video data for use in internet protocol television (IPTV) applications.
